(19) United States
(12) Patent Application Publication
(10) Pub. No.: US 2016/0163282 A1
(43) Pub. Date: Jun. 9, 2016

(54) FLEXIBLE DISPLAY PANEL AND OPERATION METHOD THEREOF

(71) Applicant: AU Optronics Corporation, Hsin-Chu (TW)

(72) Inventors: Hsiang-Yuan Hsieh, Hsin-Chu (TW); Min-Yao Lu, Hsin-Chu (TW); Chin-Tang Chuang, Hsin-Chu (TW)

(21) Appl. No.: 14/619,212

(22) Filed: Feb. 11, 2015

(30) Foreign Application Priority Data
Dec. 3, 2014 (TW) 103142051

(51) Int. Cl. G09G 5/00; G09G 5/38; G06F 1/16; G09G 5/36; G06F 3/041

(52) U.S. Cl. CPC G09G 5/006; G09G 5/363; G06F 3/0412; G06F 1/1652; G09G 5/38; G09G 2380/02; G09G 2356/00; G09G 2354/00; G09G 2340/0464; G09G 2330/021; G09G 2330/027; G09G 2320/08

(57) ABSTRACT

A flexible display panel and an operation method of the flexible display panel are provided. A first region, a second region, and a center region are defined in the flexible display panel. The operation method includes the following steps: determining whether there is a bended place in the center region, determining whether there is a user position by detecting in the direction toward which the first region faces and the second region faces when there is the bended place in the center region, and displaying a main picture in the first region or the second region selectively according to the position of the bended place and the user position.

### CROSS-REFERENCE TO RELATED APPLICATIONS

This non-provisional application claims priority under 35 U.S.C. §119(a) on Patent Application No. 103142051 filed in Taiwan, R.O.C. on Dec. 3, 2014, the entire contents of which are hereby incorporated by reference.

### TECHNICAL FIELD

The disclosure relates to a display panel and an operation method thereof, and particularly relates to a flexible display panel and an operation method thereof.

### BACKGROUND

With the progress of the technology and the manufacturing process, a variety of electronic devices enters the market. The field of the display panels experiences a large revolution, and the flexible display panels in said field have great potential.

Although the dimensions of a flexible display panel realizable enlarge, a user might not able to use a flexible display panel with large dimensions conveniently. For example, the user may fold the flexible display panel adequately when he/she is on train of the Mass Rapid Transit or on bus so as to use the flexible display panel conveniently.

However, a quality of display in the folded region of the flexible display panel degrades, and so as the user experience and the information reliability. The user is not easily to watch the displayed contents when the flexible display panel is folded. Additionally, the user, under certain circumstances, tends to hold and operate the flexible display panel, and so as the difficulty of operating the flexible display panel increases.

### SUMMARY

According to an embodiment, an operation method of a flexible display panel having a first region, a second region, and a center region in a display region of the flexible display panel comprises the steps of: determining whether the center region has a folded region, determining whether a user is detected in a direction which the first region faces or in a direction which the second region faces when the center region has the folded region, and selectively displaying a primary picture in the first region or in the second region based on a position of the user.

According to an embodiment, a flexible display panel having a first region, a second region, and a center region in a display region of the flexible display panel comprises a folding sensor, a first image sensor, a second image sensor, and a controller. The folding sensor is in the center region and for determining whether the center region has a folded region and a position of the folded region. The first image sensor is in the first region and for determining whether a user is detected in a direction which the first region faces when the center region has the folded region. The second image sensor is in the second region and for determining whether the user is detected in a direction which the second region faces when the center region has the folded region. The controller is coupled to the folding sensor, the first image sensor, and the second image sensor. The controller is for selectively displaying a primary picture in the first region or in the second region based on a position of the user.

### BRIEF DESCRIPTION OF THE DRAWINGS

The present invention will become more fully understood from the detailed description given herein below and the accompanying drawings which are given by way of illustration only and thus are not limitative of the present invention and wherein:

FIG. 1A is an outward appearance diagram of a flexible display panel according to one embodiment of the present disclosure;

FIG. 1B is a diagram illustrating a user operating a flexible display panel according to one embodiment of the present disclosure with one hand;

FIG. 2 is a system block diagram of a flexible display panel according to one embodiment of the present disclosure;

FIG. 3A is an operation diagram of the flexible display according to another embodiment;

FIG. 3B illustrates the definition of the regions of the flexible display corresponding to FIG. 3A;

FIG. 3C is another operation diagram of the flexible display according to another embodiment;

FIG. 3D illustrates the definition of the regions of the flexible display corresponding to FIG. 3C;

FIG. 3E is yet another operation diagram of the flexible display according to another embodiment;

FIG. 3F illustrates the definition of the regions of the flexible display corresponding to FIG. 3E;

FIG. 3G is still another operation diagram of the flexible display according to another embodiment;

FIG. 3H illustrates the definition of the regions of the flexible display corresponding to FIG. 3G;

FIG. 4A through FIG. 4D illustrate the operations of the flexible display panel according to another embodiment;

FIG. 5A through FIG. 5C illustrate the operations of the flexible display panel according to another embodiment;

FIG. 6A through FIG. 6D illustrate the operations of the flexible display panel according to another embodiment; and

FIG. 7 is a flowchart of the operation method of a flexible display panel according to one embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

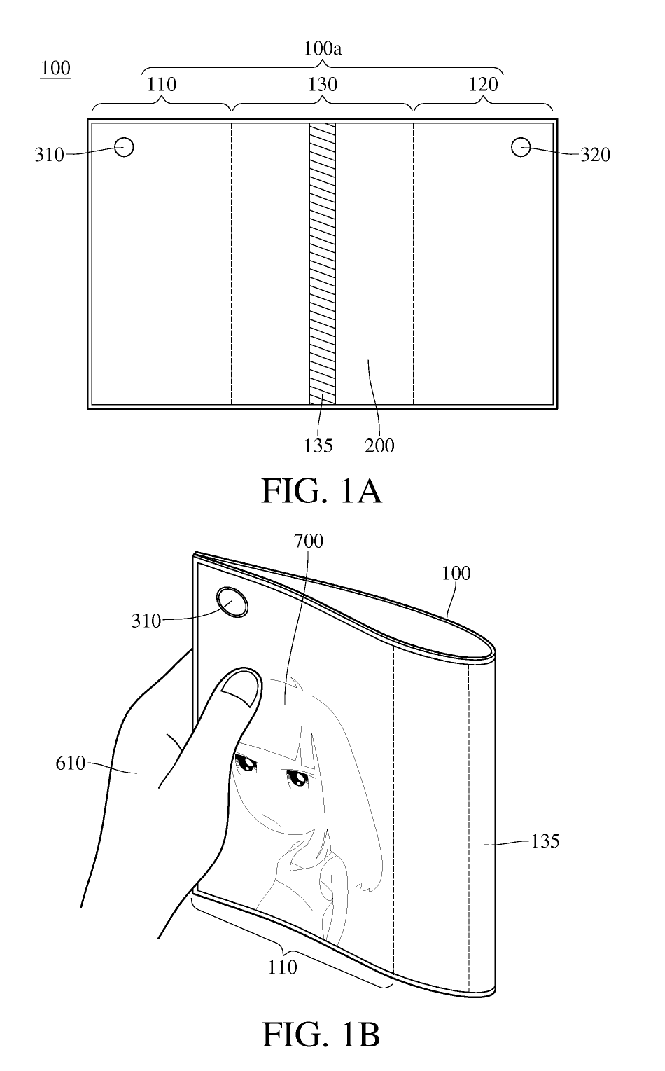

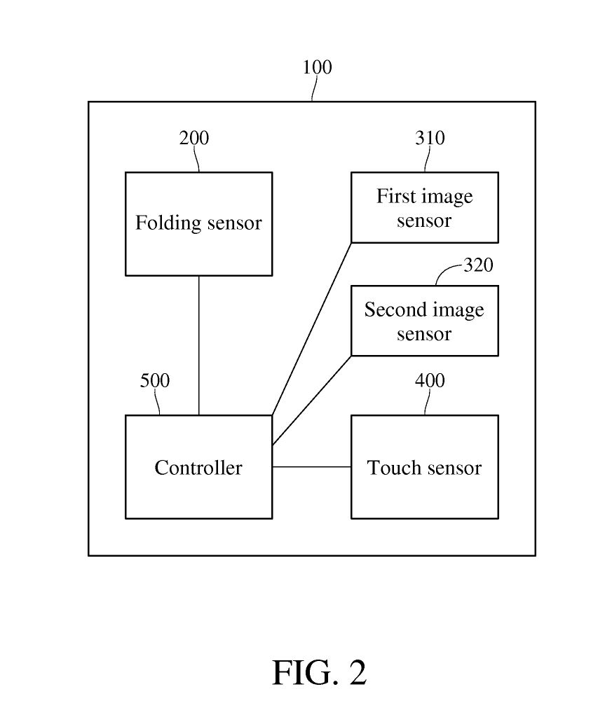

FIG. 1A is an outward appearance diagram of a flexible display panel according to one embodiment of the present disclosure. FIG. 1B is a diagram illustrating a user operating a flexible display panel according to one embodiment of the present disclosure with one hand. FIG. 2 is a system block diagram of a flexible display panel according to one embodiment of the present disclosure. Please refer to FIG. 1A, FIG. 1B, and FIG. 2. A flexible display panel 100 has a first region 110, a second region 120, and a center region 130 defined in its display region 100a. Additionally, the flexible display panel 100 has a folding sensor 200, a first image sensor 310, a second image sensor 320, a touch sensor 400, and a controller 500. The folding sensor 200 is in the center region 130. The first image sensor 310 is in the first region 110. The second image sensor 320 is in the second region 120. The controller 500 is coupled to the folding sensor 200, the first image sensor 310, the second image sensor 320, and the touch sensor 400.

The flexible display panel 100, in one embodiment, is a partially flexible panel. For example, the center region 130 of the flexible display panel 100 has the flexibility when neither the first region 110 nor the second region 120 has the flexibility. In another embodiment, all of the first region 110, the second region 120, and the center region 130 of the flexible display panel 100 are flexible. The folding sensor 200 is, in one embodiment, a folding sensing array or any other type of sensor capable of detecting the position of the folded region of the flexible display panel 100. Each of the image sensors 310 and 320 is, in one embodiment, a charge-coupled device (CCD) sensor or a complementary metal-oxide semiconductor (CMOS) sensor.

The folding sensor 200 is capable of determining whether the center region 130 has a folded region 135 and a position of the folded region 135. If the folding sensor 200 is realized with the folding sensing array as depicted in one embodiment, the controller 500 further analyzes the curvature distribution of the folding sensing array so as to determine the position of the folded region 135. For example, the controller 500 takes a region having the largest curvature within the center region 130 as the folded region 135. If there is no folded region in the whole display region 100a, the picture is displayed in the conventional way such as on the whole display region 100a of the flexible display panel 100.

The first image sensor 310 in the first region 110 is used for determining whether a user is detected in a direction which the first region 110 faces when the center region 130 has the folded region 135. The second image sensor 320 in the second region 120 is used for determining whether the user is detected in a direction which the second region 120 faces when the center region 130 has the folded region 135. The controller 500 is used for selectively displaying a primary picture 700 in the first region 110 or in the second region 120 based on a position of the user. In another embodiment, if neither the first image sensor 310 nor the second image sensor 320 detects the user, the controller 500, based on the user's preference related to the folded region 135, displays the primary picture 700 in a preset region such as the first region 110 or the second region 120.

For example, when the flexible display panel 100 is not folded, the flexible display panel 100 displays the contents to be displayed in whole display region 100a including the first region 110, the second region 120, and the center region 130. When the user folds the flexible display panel 100 and holds it with a single hand 610 as shown in FIG. 1B, the user can hold the folded flexible display panel 100 with either the first region 110 or the second region 120 towards himself/herself so as to watch the displayed contents conveniently. Then, the controller 500 determines the center region 130 has the folded region 135 therein with the help of the folding sensor 200. In one embodiment, because the first image sensor 310 in the first region 110 detects an image including the user, the controller 500 displays the primary picture 700 in the first region 110 based on the position of the user. However, the user can still hold the flexible display panel 100 with his/her two hands.

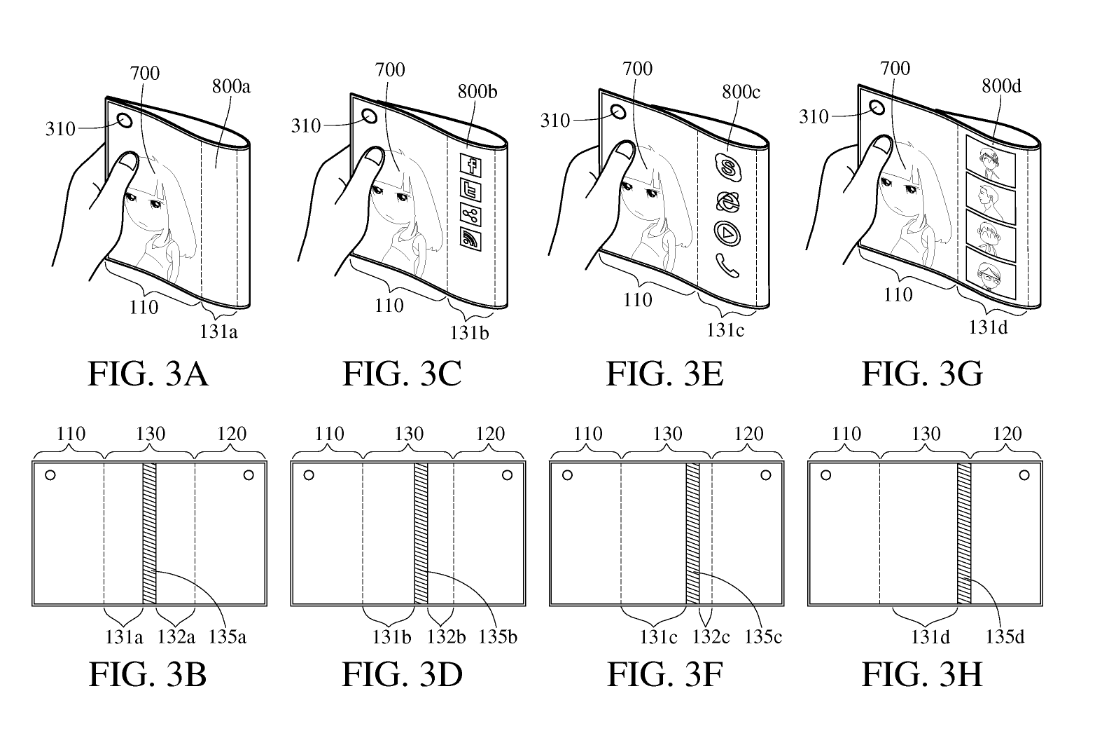

FIG. 3A is an operation diagram of the flexible display according to another embodiment, and FIG. 3B illustrates the definition of the regions of the flexible display corresponding to FIG. 3A. FIG. 3C is another operation diagram of the flexible display according to another embodiment, and FIG. 3D illustrates the definition of the regions of the flexible display corresponding to FIG. 3C. FIG. 3E is yet another operation diagram of the flexible display according to another embodiment, and FIG. 3F illustrates the definition of the regions of the flexible display corresponding to FIG. 3E. FIG. 3G is still another operation diagram of the flexible display according to another embodiment, and FIG. 3H illustrates the definition of the regions of the flexible display corresponding to FIG. 3G. When the user holds and folds the flexible display panel 100 with his/her single hand 610, the user can determine how to fold the center region 130 based on the attributes of the displayed contents, his/her convenience, and/or the size of his/her hand so as to initialize the preset position of the folded region 135. Then, the user can push or pull the flexible display panel 100 with his/her single hand 610 to change the position of the folded region 135, such as the folded region 135a in FIG. 3B or the folded region 135b in FIG. 3D.

In one embodiment, the center region 130 of the flexible display panel 100 is divided into a first sub region, such as the first sub region 131a in FIG. 3A or the first sub region 131b in FIG. 3C, and a second sub region, such as the second sub region 132a in FIG. 3B or the second sub region 132b in FIG. 3D, by the folded region, such as the folded region 135a in FIG. 3B or the folded region 135b in FIG. 3D. Take FIG. 3B for example, the first sub region 131a is between the first region 110 and the folded region 135a, and the second sub region 132a is between the folded region 135a and the second region 120. In one embodiment, when the controller 500 displays the primary picture 700 in the first region 110 based on the position of the folded region 135 and/or the position of the user, the controller 500 further display a secondary picture, such as the secondary picture 800a in FIG. 3A or the secondary picture 800b in FIG. 3C, in the first sub region 131. With similar manner, when the controller 500 displays the primary picture 700 in the second region 120, the secondary picture is displayed in the second sub region 132 in one embodiment.

In yet another embodiment, as shown in FIG. 3A through 3H, the controller 500 further detects an area of the first sub region 131 or an area of the second sub region 132 so as to select the displayed content(s) of the secondary picture 800. From FIG. 3A to FIG. 3H, the position of the folded region changes and the first sub region increases. That is, the area of the first sub region 131d is substantially larger than the area of the first sub region 131c; the area of the first sub region 131c is substantially larger than the area of the first sub region 131b; and the area of the first sub region 131b is substantially larger than the area of the first sub region 131a.

Under the circumstance depicted in FIG. 3A and FIG. 3B, the controller 500 chooses not to display the secondary picture in the first sub region 131a because the controller 500 determines that the area of the first sub region 131a is substantially less than a preset value or a preset area. Additionally, the controller 500 chooses to display the secondary picture 800b in the first sub region 131b with a list comprising buttons linking to social networks for the user to share a website content when the controller 500 determines that the area of the first sub region 131b is substantially larger than the first preset value but substantially less than a second preset value. Similarly, the controller 500 chooses to display the secondary picture 800c in the first sub region 131c with a list comprising buttons linking to the applications frequently used by the user when the controller 500 determines that the area of the first sub region 131c is substantially larger than the second preset value but substantially less than a third preset value. The controller 500 chooses to display the secondary picture 800d in the first sub region 131d with a list comprising thumbnails of files or websites when the controller 500 determines that the area of the first sub region 131d is substantially larger than the third preset value but substantially less than a fourth preset value. In other words, there is a variety of displayed contents of the secondary picture. In one embodiment, the displayed contents of the secondary picture relate to the displayed contents of the primary picture. In another embodiment, the displayed contents of the secondary picture do not relate to the displayed contents of the primary picture.

Additionally, take FIG. 3A for example, the controller 500 chooses to disable the display functionality of the second region 120 and/or the display functionality of the second sub region 132a when the flexible display panel 100 is folded by the user and the user is detected by the first image sensor 310. That is because, in such condition, the user only watches the first region 110 and/or the first sub region 131a. Similarly, the controller 500 chooses to disable the display functionality of the first region 110 and/or the display functionality of the first sub region 131a when the flexible display panel 100 is folded by the user and the user is detected by the second image sensor 320. That is because, in such condition, the user only watches the second region 120 and/or the second sub region 132a. With the aforementioned manner, the power consumption is reduced.

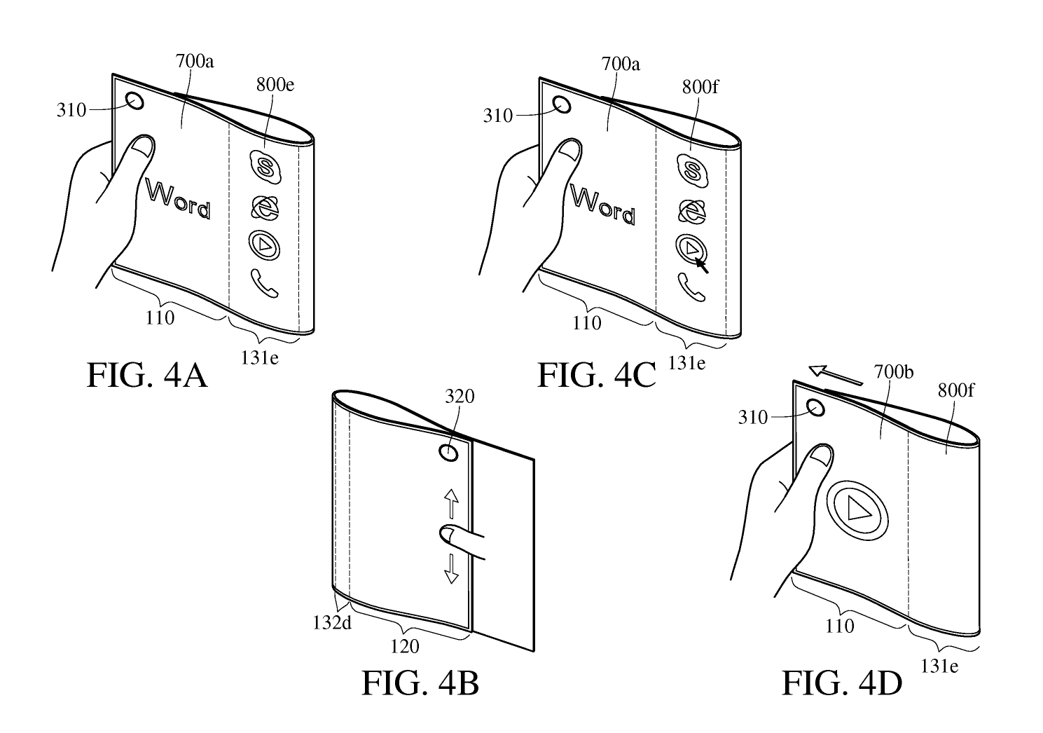

FIG. 4A through FIG. 4D illustrate the operations of the flexible display panel according to another embodiment. In one embodiment, the user controls the flexible display panel 100 with gestures by his/her hand holding and folding the flexible display panel 100. The gestures is detected by the touch sensor 400 coupled to the controller 500. The touch sensor 400 is used for detecting touch input, the gestures of the user's hand, on the surface of the second region 120 and/or on the surface of the second sub region 132d in FIG. 4B when the primary picture 700 is displayed in the first region 110, as shown in FIG. 4A. With similar manner, the touch sensor 400 is used for detecting touch input, the gestures of the user's hand, on the surface of the first region 110 and/or on the surface of the first sub region 131e in FIG. 4A when the primary picture 700 is displayed in the second region 120.

As shown in FIG. 4A and FIG. 4B, when the user is operating with a documentation application program such as WORD™ displayed in the primary picture 700a and wants to execute another application program, the user push the second region 120 away from his hand 610 so as to enlarge the first sub region 131e and to make the controller 500 to display list comprising selectable application programs in the secondary picture 800e, wherein the application programs are, for example, Skype, Internet Explorer, Media Player, and phone call. When the controller 500 determines to display the primary picture 700a in the first region 110, the touch sensor 400 detects the touch input, the gestures, on the surface of the second region 120, such as the slide of the finger of the user on the surface of the second region 120, so as to allow the user to switch his/her selection among the application programs. In other words, the user slides his/her finger on the surface of the second region 120 to select one application program displayed in the secondary picture 800e to be executed. In one embodiment, when the user slides his finger, there is a curser moving in the secondary picture 800f as shown in FIG. 4C so as to indicate the selected application program. When the curser is indicating the application program Media Player and the user pulls the second region 120 toward his hand 610, the selected application program, Media Player, is then executed and its user interface is then displayed in the primary picture 700b as shown in FIG. 4D. The touch inputs and the gestures allowed for operating the flexible display panel 100 are sliding, single click, multi-click, or any other gestures.

In another embodiment, the controller 500 further analyzes whether the displacement of the folded region 135 within a preset switching period is substantially larger than a displacement threshold so as to determine whether the touch sensing functionality of the second region 120 and/or the second sub region 132d shown in FIG. 4B is to be enabled. When the displacement of the folded region 135 is substantially larger than the displacement threshold, the controller 500 enables the touch sensing functionality of the region just being folded to become part of the second sub region. When the displacement of the folded region 135 is not substantially larger than the displacement threshold, the controller 500 does not enable the touch sensing functionality of the region just being folded to become part of the second sub region. Accordingly, the power consumption is reduced.

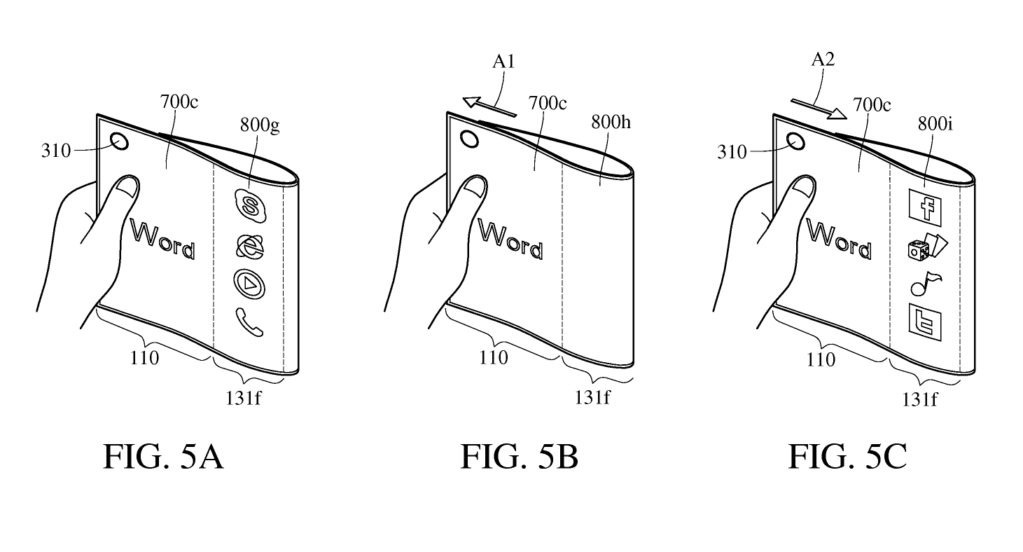

FIG. 5A through FIG. 5C illustrate the operations of the flexible display panel according to another embodiment. In one embodiment, the user can operates the flexible display panel 100 by changing the curvature distribution of the center region 130 after folding the flexible display panel 100 to display the primary picture 700 and the secondary picture 800. In the embodiment, the controller 500 further analyzes whether the displacement of the folded region 135 within a preset switching period is substantially larger than a displacement threshold. For example, as shown in FIG. 5A through FIG. 5C, the user quickly pull and push the second region 120 of the flexible display panel 100 so as to execute a certain functionality such as switching the list of the application programs. The arrow A1 in FIG. 5B and the arrow A2 in FIG. 5C respectively represent the movement of pulling the second region 120 and the movement of pushing the second region 120.

For example, when the user is operating the application program WORD shown in the primary picture 700c and the secondary picture 800g shows a list comprising other application programs such as Skype, IE, Media Player, and Phone Call, the user can pulls the second region 120 so as to change the curvature distribution of the center region 130 and those application programs originally shown in the secondary picture 800g vanishes in the secondary picture 800h displayed in the first sub region 131f. Then the user pushes the second region 120 within the preset switching period, so the list shown in the secondary picture 800i comprises other application programs such as Photoshop, Outlook, Camera, and Facebook. In other words, the user quickly pulls and pushes the second region 120 so as to switch the list shown in the secondary picture.

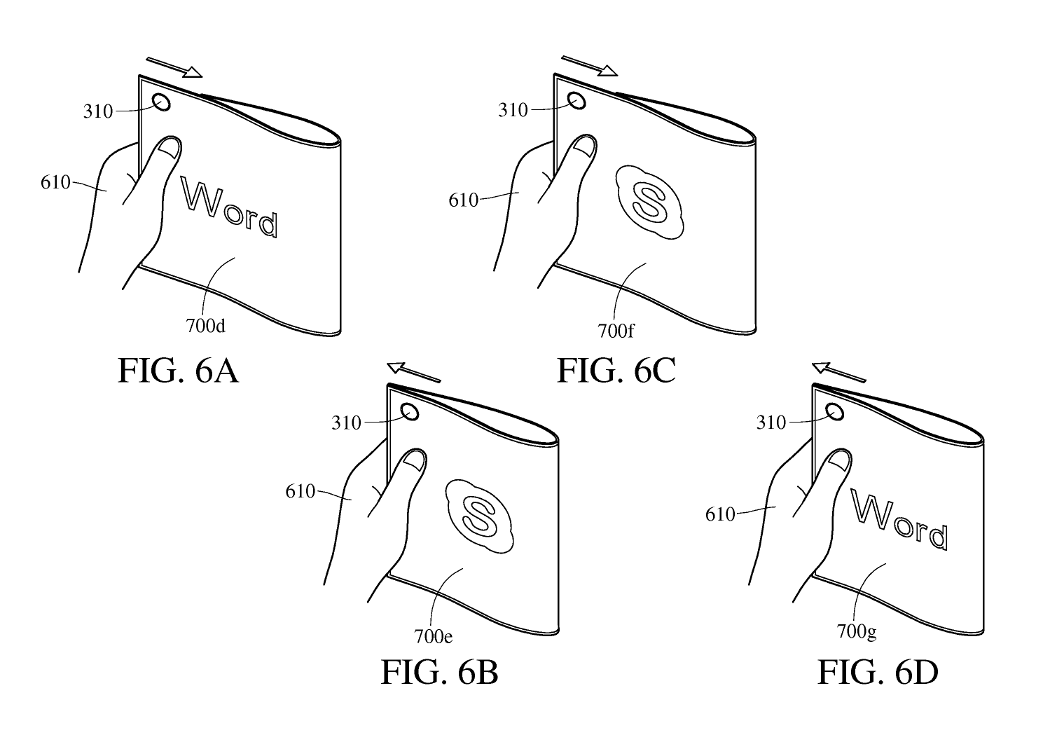

FIG. 6A through FIG. 6D illustrate the operations of the flexible display panel according to another embodiment. In another embodiment, the user can switch the application program executed and shown in the first region 110 of the flexible display panel 100 by changing the curvature distribution of the center region 130 after folding the flexible display panel 100 to display the primary picture 700 and the secondary picture 800. In the embodiment, the controller 500 further analyzes whether the displacement of the folded region 135 within a preset switching period is substantially larger than a displacement threshold so as to switch the application program in execution and shown in the first region 110. For example, as shown in FIG. 6A through FIG. 6B, when WORD is executed and shown in the primary picture 700d displayed in the first region 110 and the user quickly pull and push the second region 120 of the flexible display panel 100 within a preset switching period, the application program shown in the primary picture 700e is switched to Skype. Similarly, as shown in FIG. 6C through FIG. 6D, when Skype is executed and shown in the primary picture 700f displayed in the first region 110 and the user quickly pull and push the second region 120 of the flexible display panel 100 within the preset switching period, the application program shown in the primary picture 700e is switched to WORD. If there are numbers of application programs executed on the portable device with the flexible display panel 100, the user is allowed to switch the application program to be shown in the primary picture in the aforementioned way. That is, the functionality of quick pulling and pushing in the present embodiment is similar to pressing the button Alt and the button Tab of a computer at the same time.

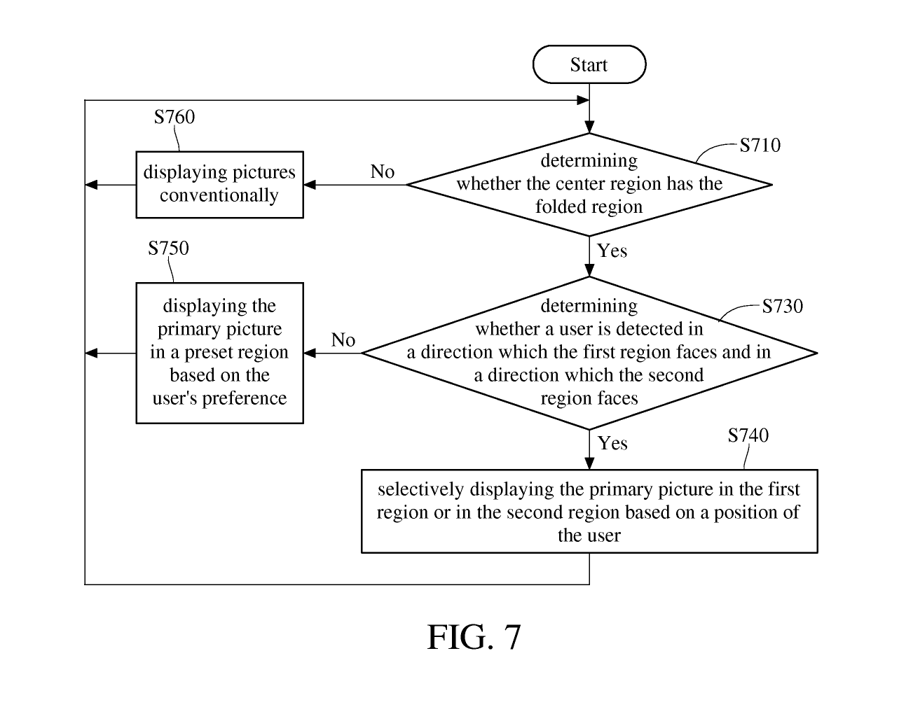

FIG. 7 is a flowchart of the operation method of a flexible display panel according to one embodiment. As shown in FIG. 7, the method comprises the steps from S710 to S760. Please refer to all figures at the same time. In step S710, the folding sensor 200 determines whether the center region 130 has the folded region 135. If the center region 130 has the folded region 135, as shown in step S730, the first image sensor 310 and the second image sensor 320 respectively determine whether a user is detected in a direction which the first region 110 faces and in a direction which the second region 120 faces. If the user is detected, as shown in step S740, the controller selectively displays the primary picture 700 in the first region 110 or in the second region 120 based on a position of the user.

If the user is not detected, as shown in step S750, the controller 500 displays the primary picture 700 in a preset region, such as the first region 110 or the second region 120, based on the user's preference. If the center region 130 does not have the folded region 135, as shown in step S760, the controller 500 chooses to display picture(s) conventionally.

What is claimed is:

1. An operation method of a flexible display panel, wherein a first region, a second region, and a center region are defined in a display region of the flexible display panel, the method comprising:
determining whether the center region has a folded region;
determining whether a user is detected in a direction which the first region faces or in a direction which the second region faces when the center region has the folded region; and
selectively displaying a primary picture in the first region or in the second region based on a position of the user when the user is detected.

2. The operation method of claim 1, wherein the folded region divides the center region into a first sub region and a second sub region, the first sub region is between the first region and the folded region, and the second sub region is between the folded region and the second region.

3. The operation method of claim 2, wherein the step of selectively displaying the primary picture in the first region or in the second region based on the position of the user comprises:
selectively displaying a secondary picture in the first sub region when the primary picture is displayed in the first region; and
selectively displaying the secondary picture in the second sub region when the primary picture is displayed in the second region.

4. The operation method of claim 3, wherein the step of selectively displaying the secondary picture in the first sub region when the primary picture is displayed in the first region comprises:
determining whether an area of the first sub region is substantially less than a preset value when the primary picture is displayed in the first region;
displaying the secondary picture in the first sub region when the area of the first sub region is not substantially less than the preset value.

5. The operation method of claim 4, wherein the step of displaying the secondary picture in the first sub region when the area of the first sub region is not substantially less than the preset value comprises:
selecting a content displayed in the secondary picture based on the area of the first sub region.

6. The operation method of claim 3, wherein the step of selectively displaying the primary picture in the first region or in the second region based on the position of the user further comprises:
disabling a display functionality of both of the second region and the second sub region when the primary picture is displayed in the first region; and
disabling the display functionality of both of the first region and the first sub region when the primary picture is displayed in the second region.

7. The operation method of claim 3, wherein one of the group consisting of the second region, the second sub region, and combination thereof is used for detecting a touch input when the primary picture is displayed in the first region.

8. The operation method of claim 3, wherein the step of selectively displaying the primary picture in the first region or in the second region based on the position of the user further comprises:
analyzing whether a displacement of the folded region within a preset switching period is substantially larger than a displacement threshold; and
when the primary picture is displayed in the first region and the displacement is substantially larger than the displacement threshold, enabling a touch sensing functionality of a region just being folded to become a part of the second sub region.

9. A flexible display panel having a first region, a second region, and a center region in a display region of the flexible display panel, the flexible display panel comprising:
a folding sensor in the center region for determining whether the center region has a folded region and a position of the folded region;
a first image sensor in the first region for determining whether a user is detected in a direction which the first region faces when the center region has the folded region;
a second image sensor in the second region for determining whether the user is detected in a direction which the second region faces when the center region has the folded region; and
a controller coupled to the folding sensor, the first image sensor, and the second image sensor, for selectively displaying a primary picture in the first region or in the second region based on a position of the user when the user is detected.

10. The flexible display panel of claim 9, wherein the folded region divides the center region into a first sub region and a second sub region, the first sub region is between the first region and the second sub region, and the second sub region is between the first sub region and the second region.

11. The flexible display panel of claim 10, wherein a secondary picture is displayed in the first sub region when the primary picture is displayed in the first region, and the secondary picture is displayed in the second sub region when the primary picture is displayed in the second region.

12. The flexible display panel of claim 11, wherein the controller further determines whether an area of the first sub region is substantially less than a preset value when the primary picture is displayed in the first region, and displays the secondary picture in the first sub region when the area of the first sub region is not substantially less than the preset value.

13. The flexible display panel of claim 12, wherein the controller further selects a content displayed in the secondary picture based on the area of the first sub region when the area of the first sub region is not substantially less than the preset value.

14. The flexible display panel of claim 12, wherein the controller disables a display functionality of both of the second region and the second sub region when the primary picture is displayed in the first region, and the controller disables the display functionality of both of the first region and the first sub region when the primary picture is displayed in the second region.

15. The flexible display panel of claim 12, further comprising:
a touch sensor coupled to the controller for detecting a touch input in the second region or in the second sub region when the primary picture is displayed in the first region.

16. The flexible display panel of claim 12, wherein the controller analyzes whether a displacement of the folded region within a preset switching period is substantially larger than a displacement threshold, and when the primary picture is displayed in the first region and the displacement is substantially larger than the displacement threshold, the controller enables a touch sensing functionality of a region just being folded to become a part of the second sub region.

17. The flexible display panel of claim 10, wherein the folding sensor is a folding sensing array, and the controller determines the position of the folded region by analyzing a curvature of the folding sensing array.
